(19) United States
(12) Patent Application Publication
(10) Pub. No.: US 2009/0028695 A1
(43) Pub. Date: Jan. 29, 2009

(54) Fluoropolymer bushings

(76) Inventors: Thomas P. Gannett, Wilmington, DE (US); Joel D. Citron, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/220,040

(22) Filed: Jul. 21, 2008

Related U.S. Application Data
(60) Provisional application No. 60/962,111, filed on Jul. 26, 2007.

(51) Int. Cl. F04D 29/12; B32B 27/04; C08L 27/12; F16J 15/16; F16C 33/20

(52) U.S. Cl. 415/174.2; 524/544; 428/297.4; 277/582

(57) ABSTRACT

A bushing-like part made from a fluoropolymer and circumferentially oriented continuous high tensile modulus fibers is useful as a part for pumps and compressors and other similar types of apparatus. These parts may be useful at high temperatures and/or very corrosive environments, often lengthen the time between required maintenance checks, and usually perform better than metal bushings under nonstandard operating conditions.

This application claims the benefit of U.S. Provisional Application No. 60/962,111, filed Jul. 26, 2007.

### FIELD OF THE INVENTION

A fluoropolymer thermoplastic bushing with circumferentially oriented continuous high tensile modulus fibers is useful as a part for pumps, such as a bushing, especially centrifugal pumps and other similar types of apparatus.

### BACKGROUND OF THE INVENTION

Pumps, especially centrifugal pumps, have many surfaces that rotate with respect to one another, in many instances one surface rotates while the other is stationary. Oftentimes these are stationary parts are bushing made of metal and the surfaces may gall each other because clearances must often be tight or small, to avoid leakage of gas and/or liquids from the pump. Rubber or other types of seals may sometimes be used, but especially in higher or lower temperature environments or corrosive environments such seals are not satisfactory. Also in many instances the seals must be load bearing (rigid), so metal to metal seals are used. However as mentioned above these have a tendency to wear and/or gall, especially when a pump runs dry for some period, or is allowed to run dry. Other types of apparatus having similar needs for such bushings include compressors, and hydraulic transmissions.

An improved type of seal is a thermoplastic seal, or bushing, containing a chopped high modulus fiber randomly oriented in a plane, the plane being perpendicular to the rotation of the shaft being sealed, see for instance DuPont™ Vespel® CR-6100 Application and Installation Guide for Centrifugal Pump Stationary Wear Parts, E. I. DuPont de Nemours & Co., Inc., Wilmington, Del., USA, March 2007. However fabrication of such parts is complicated and expensive, and cheaper ways of fabricating parts for such uses are desired, see for instance U.S. Pat. Nos. 5,470,409 and 5,427,731. The bushings made from thermoplastic polymers preferably have good wear properties and low coefficients of friction with the surfaces that move with respect to the bushings.

Composite tubes containing a thermoplastic such as a fluoropolymer and a circumferentially oriented continuous high tensile modulus fiber, and a process for making them, are described in U.S. Pat. No. 4,975,321, which is hereby included by reference. No mention is made of using these tubes for bushing applications, particularly wherein lower radial thermal coefficient of expansion is desirable.

### SUMMARY OF THE INVENTION

Disclosed herein is a bushing, said bushing comprising, a fluoropolymer thermoplastic and circumferentially-oriented continuous high tensile modulus fiber.

Also disclosed is an apparatus, comprising, a first part rotating with respect to a second part, and in between and contacting said first and said second parts a bushing comprising a fluoropolymer thermoplastic and circumferentially-oriented continuous high tensile modulus fiber.

### BRIEF DESCRIPTION OF THE DRAWINGS

FIG. 1 shows various shapes for bushings.

FIG. 2 shows the present fluoropolymer bushings in a typical centrifugal pump.

### DETAILED DESCRIPTION OF THE INVENTION

Herein certain terms are used and some of them are defined below.

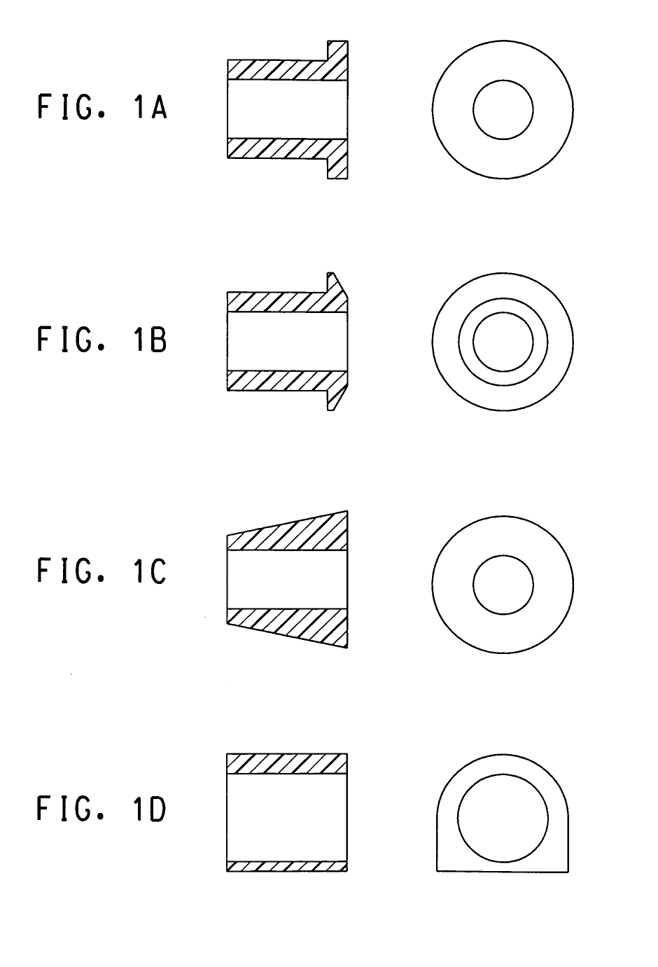

By a “bushing” or “function as a bushing” is meant a cylindrical lining designed to restrict or restrain the motion of a rotating part, which may also reduce friction and/or wear, and/or provide a seal against liquid and/or gas. At least one surface, the outer or inner surface, is cylindrical and it is preferred that the inner and outer surfaces be cylindrical. Each of the inner and outer surfaces of the bushing are in contact with a first part and second part, respectively, and the first and second parts may rotate with respect to one another. Useful parts/shapes, such as bushings are shown in FIGS. 1A-1D. Also useful are split bushings, wherein the bushing part is split into two or more pieces (usually 2 pieces cut through a diameter) when it cannot be slipped down the inner shaft.

By a “high tensile modulus fiber” (HTMF) is meant fibers having a tensile modulus of about 10 GPa or more, preferably about 50 GPa or more, more preferably about 70 GPa or more, when measured in accordance with ASTM method D885-85. If the fiber is in the form of a fabric or tow, the tensile modulus measurement will be made on a single fiber in that fabric or tow. If there is more than one type of fiber present, each type shall be measured to determine if it is an HTMF. Fibers not meeting the requirements for an HTMF shall not be considered in the total amount of HTMF present, thus HTMF and non-HTMF may be present.

By a “continuous” fiber is meant fiber having a length of about 3 cm or more, preferably at least about 10 cm or more, preferably 1 meter long. If the fiber is not truly continuous, but cut into lengths, it is preferred that the fiber lengths overlap one another in the composite. Not all of the fiber in the composite need be circumferentially oriented.

By “circumferentially oriented” is meant that the fiber is oriented approximately parallel to the circumference of a circular inner or outer surface of the bushing. It need not be perpendicular to the center axis of the circular inner or outer surface, but may be at an angle, for example forming a helix with respect to that axis. The fiber is not considered circumferentially oriented if it is oriented 0° with respect to the axis of the cylinder.

By “in contact with” is meant that the two surfaces are in contact with each other at least some of the time. Thus between a circular inner surface of the bushing part and a circular shaft within that surface there may be some small clearance so that the shaft may rotate within the bushing. This is considered to be “in contact with”, even if there is a thin film of a liquid or gas between the two surfaces. This thin film may act as a lubricant.

By a “fluoropolymer” is meant a synthetic organic polymer containing fluorine, preferably at least about 5 weight percent fluorine and which is a thermoplastic.

By a “thermoplastic” is meant a polymer which may be reformed by melting the thermoplastic and then cooling it below its melting point and/or glass transition temperature. Such polymers are not crosslinked. They have a melting point and/or glass transition temperature above 30° C., preferably above 100° C., when measured by differential scanning calorimetry. Preferably the melting point above 30° C. has a heat of fusion of about 3 J/g or more, more preferably about 5 J/g or more.

Disclosed herein is a busing, wherein the bushing comprises fluoropolymer thermoplastic and circumferentially-oriented continuous high tensile modulus fibers. The bushing of the present invention is useful as a part for pumps and compressors and other similar types of apparatuses. These parts may be useful at high temperatures and/or in very corrosive environments, often lengthen the time between required maintenance checks, and usually perform longer and better than metal bushings under nonstandard operating conditions.

Preferably both the inner and outer part surfaces of the bushing are circular (cylindrical), and more preferably the center axes of both these circles are concentric.

Preferably one or both of the first and second surfaces in contact with the bushing part is metal.

It is also preferable that the high tensile modulus fiber have a thermal coefficient of expansion at the normal use temperature bushing of less than about 1×10⁻⁵ cm/cm/° C., more preferably less than about 1×10⁻⁶ cm/cm/° C. The service temperature of a busing disclosed herein will depend greatly on the thermal properties of the thermoplastic from which it is made. If the bushing is to be used over a wide temperature range and that range includes 23° C., the coefficient of expansion should be measured at about 23° C. If that range does not include 23° C., that range should be measured at the midpoint of the range.

Useful fibers include carbon fibers, aramid fibers, metal fibers (wire), glass fibers, and ceramic fibers. The fibers may be sized to improve their adhesion to the fluoropolymer thermoplastic. Essentially fibers which are very long (over 1 meter) are preferred in at least fabrication of the preform for the bushing, although the fibers in the final bushing may, in part, be shortened because they are cut during final formation of bushing, as by machining.

It is preferred that the continuous high tensile modulus continuous fibers which are circumferentially oriented be about 10 to about 70, more preferably about 20 to about 60 volume percent, of the total fluoropolymer thermoplastic composition (i.e., the bushing).

The bushing may be made as described in U.S. Pat. No. 4,975,321, incorporated herein by reference, which describes a filament winding-like process using fibers, including HTMF, in the form of impregnated tow or unitape, to form for instance a tube from the HTMF and a fluoropolymer. The fiber, tow or unitape may be wound in the winding process at some angle other than 90° or 0° to the axis of the cylinder, thereby forming a helix. The preferable angle for the fiber is about 35° to about 55°, more preferably about 45° to the axis of cylinder. It may then be consolidated by compression molding, or bag molding in an autoclave (a bag is placed around shape, the bag is evacuated, placed in an autoclave and heated, optionally with pressure applied to the outside of the bag). Alternatively as the impregnated fiber is wound around in the filament winding process it may be heated so as to cause the thermoplastic to flow and consolidate as the impregnated fiber is wound. Upon cooling a solid part may be obtained.

Impregnated fiber, for example an impregnated tow, may be obtained by, for instance, passing the unimpregnated tow through a thermoplastic polymer or fluoropolymer latex emulsion or suspension, coagulating (as by freezing) the polymer after the tow wet with emulsion or suspension leaves the bath, and then drying the tow.

This may give the final bushing, but since these bushings often have tight size tolerances, and/or are irregularly shaped, a tubelike preform may be formed by the compression molding, and the preform is then machined into one or more bushings. These machining processes are well known for composites made from fluoropolymers and HTMF, see for instance Vespel®CR-6100 & 6200, General Machining Guide, E. I. DuPont de Nemours & Co., Inc., Wilmington Del., USA, 2003. For instance these materials can be shaped by sawing, drilling, turning, milling and grinding.

Useful fluoropolymers have a melting point and/or glass transition temperature of about 150° C. or more, more preferably about 200° C. or more, and especially preferably about 250° C. or more. If the bushing is exposed in service to chemical(s) the fluoropolymer thermoplastic should be relatively unaffected by those chemical(s) at the service temperature. Blends of fluoropolymer thermoplastics may be also used.

Preferred fluoropolymers are perfluoropolymers, especially homo- and copolymers of tetrafluoroethylene (TFE) (herein the homopolymer of tetrafluoroethylene is considered a thermoplastic, even though it does not flow well above its melting point). Useful copolymers of TFE include those containing hexafluoropropylene or perfluoro(alkyl vinyl ether). It is preferred that the fluoropolymer thermoplastic has a melting point and or glass transition temperature of about 200° C. or more, more preferably about 250° C. or more. Melting points, heats of fusion, and glass transition temperatures are measured by ASTM Method D3418, using a heating rate of 110° C./min. Melting points are taken as the maximum of the melting endotherm, while the glass transition point is taken as the midpoint of the transition, and both are measured on the second heat. If more than one melting point is present the melting point of the polymer is taken as the highest of the melting points.

Other useful fluoropolymers include polyvinylidene fluoride, a copolymer of ethylene and vinyl fluoride, a copolymer of ethylene and tetrafluoroethylene, and poly(chlorotrifluoroethylene). It is preferred that the fluoropolymer contain at least about 45 weight percent fluorine.

The bushings are useful in many types of equipment especially where there are rotating shafts, and where there is an interface between those shafts and another piece of the equipment that must be sealed against leakage of liquid and/or gas.

Thus one preferred type of equipment which may comprise the bushing is pumps, especially centrifugal pumps. These bushings are useful in centrifugal pumps as stationary wear rings and throat bushings in overhung and vertical inline pumps and single stage between bearing pumps, as stationary wear rings, throat bushings, inter-stage bushings and pressure-reducing bushings in multi-stage horizontal pumps, and as stationary wear rings, inter-stage bushings, line shaft bearings and throat bushings in vertical pumps.

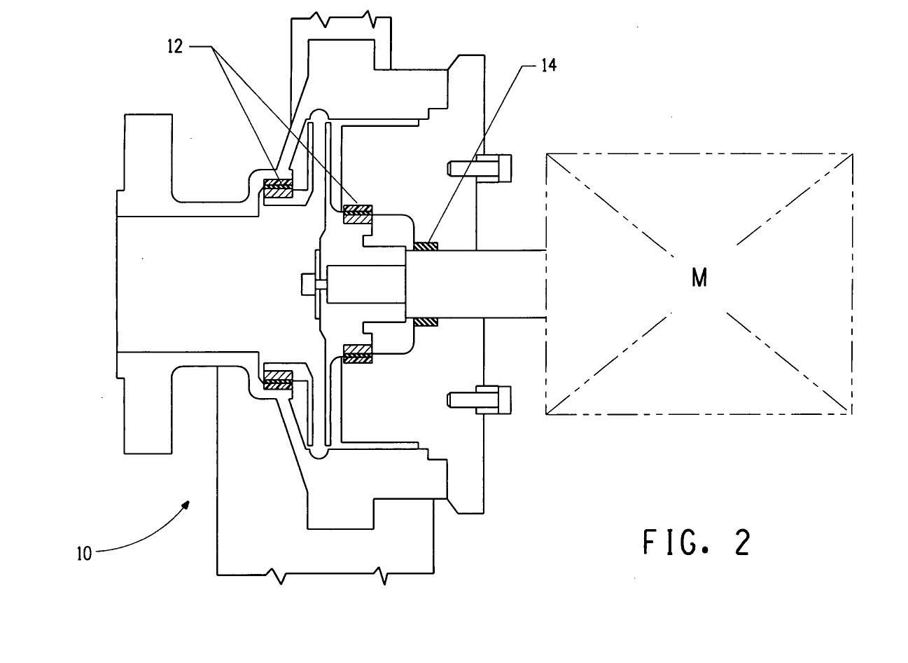

FIG. 2 shows a partially cutaway drawing of a horizontal one-stage centrifugal pump, showing the configurations and location of the bushings of this invention. In FIG. 2 shows the present fluoropolymer bushings in a typical centrifugal pump.

One embodiment of the present invention is an apparatus, comprising, a first part rotating with respect to a second part, and in between and contacting said first and said second parts a bushing comprising a fluoropolymer thermoplastic and circumferentially-oriented continuous high tensile modulus fiber.

Another type of apparatus which may comprise the bushing is a compressor wherein the bushings may be used as piston and rider rings. Other useful apparatuses are hydraulic transmissions.

When mounted in the apparatus it is preferred that the bushings are mounted in compression. Thus the part may be compressionally force fit into the part of the apparatus around the outer surface of the bushing.

What is claimed is:

1. A bushing, said bushing comprising, a fluoropolymer thermoplastic and circumferentially-oriented continuous high tensile modulus fiber.

2. The bushing as recited in claim 1 wherein said high tensile modulus fiber carbon fiber, aramid, fiber, metal fiber, glass fiber or ceramic fiber.

3. The bushing as recited in claim 1 which is fabricated with said continuous high tensile modulus fibers, wherein said fibers are over 1 meter long in at least fabrication of preform.

4. The bushing as recited in claim 1 wherein said high tensile modulus fibers are about 20 to about 60 volume percent of said bushing.

5. The bushing as recited in claim 1 wherein said fluoropolymer has a melting point of about 200° C. or more.

6. The bushing as recited in claim 1 wherein said fluoropolymer is a perfluoropolymer.

7. An apparatus, comprising, a first part rotating with respect to a second part, and in between and contacting said first and said second parts a bushing comprising a fluoropolymer thermoplastic and circumferentially-oriented continuous high tensile modulus fiber.

8. The apparatus of claim 7 which is a centrifugal pump.

9. The apparatus of claim 7 which is a pump, compressor or hydraulic transmission.

10. The apparatus as recited in claim 7 wherein said high tensile modulus fiber carbon fiber, aramid, fiber, metal fiber, glass fiber or ceramic fiber.

11. The apparatus as recited in claim 7 which is fabricated with said continuous high tensile modulus fibers, wherein said fibers are over 1 meter long.

12. The apparatus as recited in claim 7 wherein said high tensile modulus fibers are about 20 to about 60 volume percent of said bushing.

13. The apparatus as recited in claim 7 wherein said fluoropolymer has a melting point of about 200° C. or more.

14. The apparatus as recited in claim 7 wherein said fluoropolymer is a perfluoropolymer.
